(19) United States
(12) Patent Application Publication
(10) Pub. No.: US 2002/0075496 A1
(43) Pub. Date: Jun. 20, 2002

(54) Software interface adapter for internet communication

(76) Inventors: Yan Zhang, Edina, MN (US); James J. Sun, New Brighton, MN (US); Nicolas T. Gao, Edina, MN (US); Weiguang Shao, Woodbury, MN (US); Qi-Bin Bao, Bloomington, MN (US); Julia Zhang, Edina, MN (US); Kejia Sun, New Brighton, MN (US)

Correspondence Address: Christopher R. Christenson, WESTMAN CHAMPLIN & KELLY, International Centre - Suite 1600, 900 Second Avenue South, Minneapolis, MN, 55402-3319, US

(21) Appl. No.: 09/737,214

(22) Filed: Dec. 14, 2000

Related U.S. Application Data
(60) Provisional application No. 60/220,923, filed on Jul. 26, 2000.

(51) Int. Cl. G06F 15/00; G06K 1/00

(52) U.S. Cl. 358/1.13; 358/1.12

(57) ABSTRACT

A method and system are provided which receive information from a non-standard source, in a relatively standardized manner. The received information is operated upon using an artificial intelligence module to translate the received information into a standardized internet protocol, such as XML (extensible Mark-Up Language).

### BACKGROUND OF THE INVENTION

The present invention relates to communication across a global computer network, such as the internet. More specifically, the present invention relates to a technique for communicating between software applications of varying types across the global computer network.

Businesses and other entities are beginning to utilize the internet more and more for communication. Such communication facilitates business interaction in a way that was previously impossible. Further, businesses can now provide their products and services directly to customers. These exchanges (business to business and business to customer) comprise what is currently known as e-commerce. Companies that embrace e-commerce are leveraging the internet to gain closer alignment with their customers and partners, to integrate supply chains, and to take advantage of new revenue growth and other opportunities.

E-commerce relies upon electronic communication of data between entities such as businesses and customers. However, e-commerce is still in relative infancy and a vast array of data types, formats, and protocols are currently used, all of which combine to hinder connectivity and slow the proliferation of e-commerce. For example, large companies often use sophisticated intranets for internal business processing including communication, management, inventory control, purchasing, etc. These kinds of intranets are often custom-built to meet the specific needs of the companies. As a result, data passing these intranets are generally incompatible with each other as well as the networks of other businesses and customers. Thus, such intranets cannot communicate with other intranets as well as the networks of other internet entities. Small companies generally use commercial products for limited business functions such as accounting, invoicing, billing, maintaining customer information, etc. During the past few decades, numerous types of business software applications have been developed by thousands of software companies for different industries and different applications. As a result, there currently exist hundreds, if not thousands of incompatible electronic data formats. E-commerce integration for converting these incompatible data standards into a format that is relatively universal is essential for growth of internet e-commerce. Market leaders in virtually every industry, whether driven by the particular needs of the industry or a cross-industry initiative, have undertaken numerous steps to integrate e-commerce since such leaders recognize the potential benefits of e-commerce integration.

Most internet entities in e-commerce have focused on big companies by providing such companies with specialized application software that automates their business processes. New e-commerce solutions are providing a number of opportunities to improve business processes, inventory controls, customer relationships, revenue and costs, etc. However, the incompatibilities between the new e-commerce software applications and the companies' existing internal systems have been a stumbling block that has hindered broad based implementation of e-commerce solutions. The utility of e-commerce generally hinges upon whether the e-commerce solution can be easily integrated with existing systems. This is because existing internal systems, which often took many years to build up, are generally too costly to be replaced or otherwise discarded. A need for standardization of business processes and terminology related to electronic exchange of information among companies and other internet entities has emerged as one of the top priorities in the e-commerce revolution.

Thus, there exists a continuing need to provide internet communication between and among the vast array of different internet communication standards and protocols.

### SUMMARY OF THE INVENTION

A method and system are provided which receive information from a non-standard source, in a relatively standardized manner. The received information is operated upon using an artificial intelligence module to translate the received information into a standardized internet protocol, such as XML (extensible Mark-Up Language).

### BRIEF DESCRIPTION OF THE DRAWINGS

FIG. 1 is a diagrammatic view of a system incorporating an adapter for internet communication, in accordance with an embodiment of the present invention.

FIG. 2 is a system block diagram of a specific embodiment for converting electronic data of virtually any format into a standard format.

FIG. 3 is a system block diagram illustrating the utility of embodiments of the present invention with electronic data, as well as image data such as that from a scanner.

### DETAILED DESCRIPTION OF THE PREFERRED EMBODIMENTS

EXtensible Mark-Up Language (XML) has emerged as a promising technology for e-commerce integration. XML is a meta language written in SGML that allows one to design a mark-up language, used to facilitate interchange of documents on the World Wide Web. Specifically, XML provides a way to tag data in a meaningful way and use the tagged data (an XML data format) as an intermediate format for electronic data interchange between the systems. A number of internet companies are cooperating to drive the rapid, consistent adoption of XML to enable electronic commerce and application integration. Although XML represents a significant advance in the standardization of data interchange upon the internet, significant limitations remain, which hinder widespread proliferation of e-commerce.

The primary problem currently hindering e-commerce has been due in part to the lack of a single unifying communication standard to provide interoperability between and among various computer systems as well as internal networks. Since internet communication is essentially global communication, it involves countries all over the world. It may take many years to reach an agreement for a single unifying standard and for such standard to be implemented. Further, even when such standard is implemented, the integration to companies' internal systems such as intranets or business software will remain a large burden to any company since each company's system must still be individually converted or integrated to comply with the standard. Further still, such conversion or integration requires vast resources and will likely be extremely costly. For example, converting a Fortune 100 company's intranet to XML format can cost several hundreds of millions of dollars. Thus, many small and mid-sized companies will simply not be able to afford such integration.

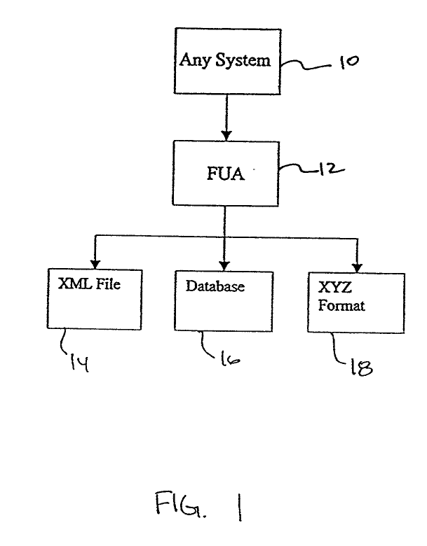

FIG. 1 is a diagrammatic view of a system for integrating dissimilar software systems for internet communication and e-commerce. Embodiments of the invention provide a generic solution to e-commerce integration. FIG. 1 illustrates system 10, which can be any system ranging from a single system such as a personal accounting system to an entire enterprise-wide local area network. System 10 provides data to software adapter 12 labeled FUA. Software adapter 12 can provide data in a number of formats such as an XML file 14, a database 16, or an alternate format 18 labeled XYZ format. For reasons that will become apparent later in the Specification, the universal adapter software of embodiments of the present invention provides system integration at much lower costs than commercially available technology. For example, system integration based upon commercially available technology to convert various data formats to XML ranges from approximately $10,000 for very limited integration of a very small-scale system to a few hundred million dollars for a complex system. Further, XML conversion can run as high as $15,000 per format page of electronic data. By comparison, FUA adapter 12 can provide system integration much more cost effectively than systems of the prior art. Thus, embodiments of the present invention are particularly suited for small to mid-sized companies that plan to conduct electronic commerce.

Embodiments of the present invention are adaptable to at least two types of integration for the electronic exchange of data. Specifically, embodiments can be used for unidirectional data transfer, as well as bi-directional data transfer.

Unidirectional data transfer is useful for companies that normally use small scale internal systems and/or commercial software for limited business practices such as accounting, payroll, invoice, and inventory management. For electronic commerce, such companies generally desire the ability to send data such as an invoice, or other data, electronically from their system via the internet or via an internet B2B solution to their client. Such companies do not wish to allow access to their systems from the internet since, for instance, such access requires that a number of security concerns be addressed before such systems can safely be placed on the internet. For such companies, integration is preferably one-way communication. Thus, if such companies use a B2B e-commerce solution to conduct their business process, it will generally be sufficient that the integration provide the capability to send information such as an invoice, a shipping list, or other suitable data from the internal system via the internet B2B solution to the partners and/or of such companies.

Bi-directional communication capabilities are especially useful for mid and large sized companies and require full two-way communication. Such companies may need to supply exchange information with suppliers, partners, and/or clients for conducting e-commerce. Currently, a number of companies are developing systems that can connect internal systems of such mid and large sized companies to suppliers for B2B e-commerce. For such systems, all electronic data output from the system to other systems and from other systems to such systems generally needs to be converted to a standardized format such as XML.

One method for conducting e-commerce over the internet is disclosed in co-pending application Ser. No. 09/649,830, filed Aug. 29, 2000, and entitled METHOD AND SYSTEM FOR CONDUCTING INTERACTIVE BUSINESS PROCESSES AND COMMUNICATIONS, assigned to the Assignee of the present invention. Embodiments of the present invention provide a relatively low-cost integration method for e-commerce practice such as the above-identified e-commerce method. The provision of a low-cost integration method significantly facilitates the acceptance of e-commerce for small and mid-sized companies with limited budgets.

One of the standards that appears to be emerging for electronic data exchange via the internet is XML. Although much of the discussion of embodiments of the present invention will focus upon converting data to XML format, it should be understood that other standardized data formats can be used. When data is converted to the standardized format, such as XML, the conversion is considered complete since the data is then in a standardized format that can be easily recognized and converted to other format.

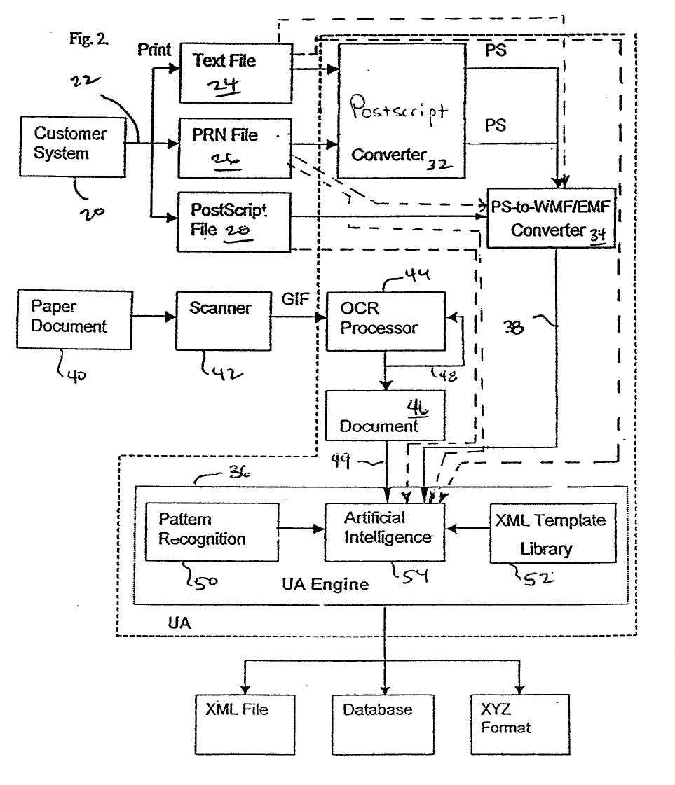

FIG. 2 is a system block diagram of a method for converting data to a standardized format in accordance with one embodiment of the present invention. While standardized formats, such as XML, are highly useful for internet data exchange, virtually all applications and software are not configured for providing data in such a standardized format. One embodiment of the present invention utilizes the printing function that is essential for virtually all business practices to essentially capture data. Since virtually all systems and/or software support a printer, such support is relatively universal. Referring to FIG. 2, customer system 20 can be any combination of hardware and/or software that is useful to output data of a printing format. Line 22 represents printer output. As can be seen, printing output 22 can be in any suitable form such as text file 24, a PRN file 26, or a Postscript file 28.

When a text file format, such as text file 24 is used, a Postscript converter 32 can be used to convert the text file to Postscript format. However, the text file can be provided directly to converter 34 or even to engine 36 itself. When a PRN file is used, the Postscript converter 32 can also be used to convert the PRN file to Postscript format. However, in some embodiments, the PRN data is provided directly to converter 34 or even to engine 36 itself. As can be seen, the output of converter 32 is provided to Postscript-to-Windows Metafile (WMF)/Enhanced Windows Metafile (EMF) converter 34. In embodiments where customer system 20 provides printing output 22 in a Postscript file format 28, it is generally unnecessary to use a converter such as converter 32 and thus the Postscript file 28 can be provided directly to Postscript-to-WMF/EMF converter 34. Since data is acquired through the well-supported printing function, no special software is required from the client for the conversion. Moreover, the system described with respect to FIG. 2 is also platform-independent since almost all systems support printing output formats such as Postscript.

Postscript-to-WMF/EMF converter 34 is preferably commercially available converting software available from various vendors which converts Postscript data into a Windows Metafile and/or Enhanced Windows Metafile. Converter 34 provides its metafile data to Universal Adapter (UA) engine 36 as indicated by arrow 38. Engine 36 essentially matches incoming form data with printing patterns and position information of various business data and forms. The result of such pattern matching is an output corresponding to the matched form, which output file is in the form of an internet standard data format such as XML. As can be seen in FIG. 2, data such as text file 24 or Postscript file 28 can also be provided directly to engine 36 without first passing through conversion modules such as converter 32.

FIG. 2 also illustrates another feature of the invention where a paper document 40 is converted into an internet-standard format such as XML. In the embodiment shown, paper document 40 is provided to scanner 42 which essentially digitizes an image of paper document 40 and provides the digitized image in a known format such as Graphics Interchange Format (GIF), TIFF, bitmap, PCX, JPEG, or any other suitable formats. The graphical file is preferably provided to processor 44 which analyzes the image information to extract data in textual form, such as in a text file, or word processing document. Preferably, processor 44 is conventional Optical Character Recognition software. Processor 44 provides as its output a document 46 in a known format such as a text file or a file in the format of Microsoft Word, which application is available from Microsoft Corporation, of Redmond, Washington. As illustrated by arrow 48, the analytical process of relating graphical information to textual data can be done iteratively such that multiple outputs are fed back to processor 44 in order to refine the final output 49. Document 46 is then fed to, or otherwise provided to pattern matching engine 36 for conversion into an internet-standard format.

Engine 36 preferably includes pattern recognition module 50, XML template library 52, and artificial intelligence module 54. Engine 36 includes recognition data containing pattern and position information for a variety of business data and forms. Data entering engine 36, in the format of a Windows Metafile, Enhanced Metafile, or Postscript text file is compared with the pattern information stored in pattern recognition module 50 to determine the original business meaning of the incoming data. For example, if the incoming data file matches the pattern of an Invoice form in the library of engine 36, the file is then labeled as an Invoice form and all items in the form are labeled correspondingly in XML format. For example, if the pattern and position information for an Invoice form in library 50 indicates that data at a specific location presents the “date” of the Invoice, the data at the same location of the incoming file will be labeled as the “date” of the invoice using XML formal.

When new data first enters engine 36, the user generally is required to teach engine 36 to recognize the pattern of the incoming data. Engine 36 has an interactive screen for use in receiving the form pattern into pattern recognition module 50 of engine 36. Each distinct business form generally needs to be entered into engine 36 once. However, engine 36 also allows users to re-teach or overwrite the pattern and position of an existing form in order to correct recognition errors.

After teaching engine 36 a pattern of each distinct new form, engine 36 creates an internet-standard template, such as an XML template, for automatic conversion of incoming files to the internet-standard file. For example, if the data in a specific location in a form is the word “invoice”, the XML template will be built to automatically label the data at the same location in the incoming file of identical patterns as the word “invoice”. The use of predefined XML templates significantly speeds file conversion to XML.

Engine 36 can also include additional built-in features to facilitate pattern/position recognition. For example, engine 36 can be taught to recognize errors in converting the incoming file to XML format. One such example occurs when engine 36 has been taught that the invoice number of a specific Invoice form should have six digits, and that the six digit number should follow the letter exactly spelled as the “Invoice”. In such example, engine 36 will not accept any data or provide conversion if the definition of “Invoice Number” is not met. Engine 36 may also be taught to make corrections in situations of obvious error. For example, engine 36 can do an automatic spelling check to correct obvious spelling errors.

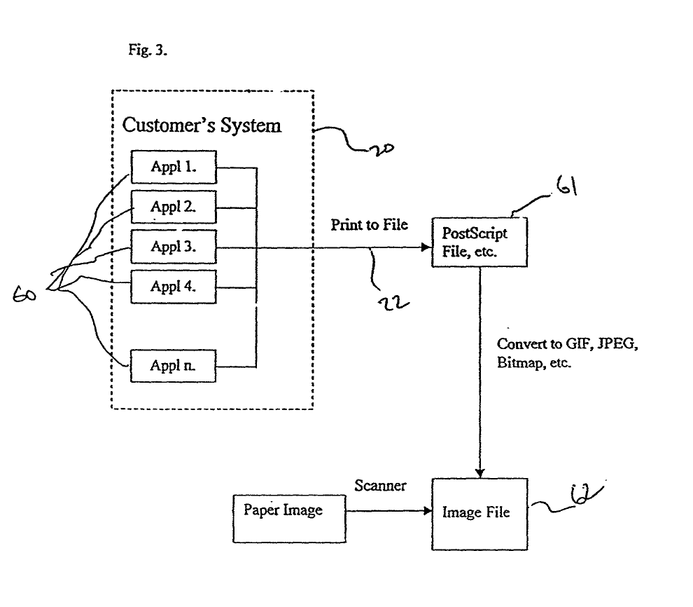

FIG. 3 is a system block diagram illustrating the utility of embodiments of the present invention with electronic data, as well as image data such as that from a scanner. Customer system 20 may run a number of applications 60. Each application 60 will support the printing function, and thus about may be received from any of application 60 through printing output 22. The format of the printing output can be any suitable file format 62 such as Postscript. The printing format is then converted to a graphical image in the form of a GIF, JPEG, Bitmap, etc. file. This image file can be accessible over the internet. This procedure is especially useful for applications where the business does not want other entities to actually change data in the form. However, image file 62 may be provided to engine 36 for conversion into an internet standard formal such as XML. Those skilled in the art will recognize that the various applications 60 need not be interoperable with each other, nor with systems external to system 20. Since applications 60 provide their output through printing, interoperability is achieved.

Although the present invention has been described with reference to preferred embodiments, workers skilled in the art will recognize that changes may be made in form and detail without departing from the spirit and scope of the invention. For example, although much of the description has focused upon using XML, other suitable formats can be used as well.

What is claimed is:

1. A system for converting information from a first format to a second format, the system comprising:
a data reception module adapted to receive data in the form of a print file;
a matching engine coupled to the reception module to match at least a portion of the print file with at least one predefined form, wherein the matching engine provides the matched form as an output; and
wherein the matched form is provided in an internet standard format.

2. The system of claim 1, wherein the print file is in the format of a text file, and wherein the reception module includes a text-to-Postscript converter coupled to a Postscript-to-WMF/EMF (Windows Metafile/Enhanced Windows Metafile) converter, and wherein the WMF/EMF converter provides an output to the engine based upon the print file.

3. The system of claim 1, wherein the print file is in a format of a text file, and wherein the reception module includes a text-to-WMF/EMF converter, and wherein the WMF/EMF converter provides an output to the matching engine based on the print file.

4. The system of claim 1, wherein the print file is in a format of a text file, and wherein the reception module coupled the text file directly to matching engine.

5. The system of claim 1, wherein the print file is in the format of a PRN file, and wherein the reception module includes a PRN-to-Postscript converter coupled to a Postscript-to-WMF/EMF converter, and wherein the WMF/EMF converter provides an output to the matching engine based upon the print file.

6. The system of claim 1, wherein the print file is in a format of a PRN file, and wherein the reception module includes a PRN-to-WMF/EMF converter, and wherein the WMF/EMF converter provides an output to the matching engine based on the print file.

7. The system of claim 1, wherein the print file is in a format of a PRN file, and wherein the reception module coupled the PRN file directly to the matching engine.

8. The system of claim 1, wherein the print file is in a format of a Postscript file, and the reception module includes a Postscript-to-WMF/EMF converter, and wherein the WMF/EMF converter provides an output to the matching engine based upon the print file.

9. The system of claim 1, wherein the print file is in the format of a Postscript file, and wherein the reception module coupled the Postscript file directly to the matching engine.

10. The system of claim 1, wherein the print file is in a format of a text file.

11. The system of claim 1, wherein the print file is in a format of a PRN file.

12. The system of claim 1, wherein the print file is in a format of a Postscript file.

13. The system of claim 1, wherein the internet standard format is XML (Extensible Mark-up Language).

14. The system of claim 1, wherein the matching engine comprises a plurality of stored form data, a library of form templates in an internet standard format, and an artificial intelligence module operably coupled to the stored form data and the library, and wherein the engine employs artificial intelligence to match the stored form data to the print file and provide a form template in internet standard form based upon the match.

15. A system for converting an image to an internet standard format, the system comprising:
a reception module adapted to receive image data;
an optical character recognition module coupled to the reception module to convert the image data into a common data format;
an matching engine coupled to the optical character recognition module to receive the common format data and match at least a portion of the common format data with at least one predefined form, wherein the engine provides the matched form as an output; and
wherein the matched form is provided in an internet standard format.

16. The system of claim 15, wherein the internet standard format is XML.

17. The system of claim 15, wherein the common data format represents textual data.

18. The system of claim 15, wherein the image data is provided in a format selected from the group consisting of GIF, JPEG, Bitmap, PCX and TIFF.

19. The system of claim 15, wherein the matching engine comprises a plurality of stored form data, a library of form templates in an internet standard format, and an artificial intelligence module operably coupled to the stored form data and the library, and wherein the engine employs artificial intelligence to match the stored form data to the common format file and provide a form template in internet standard form based upon the match.

20. The system of claim 15, wherein the optical character recognition module is repeatedly called to enhance optical recognition.

21. A method of converting data to an internet standard format, the method comprising:
capturing the data as it is outputted in a print format; and
providing the capture data to a matching engine that matches the captured data to a stored form definition and provides an output file related to the matched stored definition in internet standard format.

22. The method of claim 21, wherein the captured data is in a format selected from the group consisting of Postscript, PRN, and text.

23. The method of claim 21, wherein the captured data is in a converted format selected from the group consisting of Windows Metafile, Enhanced Windows Metafile, a word processing format, and an image format.

24. The method of claim 23 wherein the image format is selected from the group consisting of GIF, JPEG, Bitmap, PCX and TIFF.

25. The method of claim 24, wherein the artificial intelligence provides at least one function selected from the group consisting of data pattern matching, length matching, spelling matching, spelling checking, and business meaning interpolation and comparison.

25. The method of claim 21, wherein the matching engine employs artificial intelligence to match the stored form to the captured data and to provide a form template in an internet standard format based upon the match.
